(19) United States
(12) Patent Application Publication
(10) Pub. No.: US 2024/0340766 A1
(43) Pub. Date: Oct. 10, 2024

(54) WTRU-TO-NETWORK RELAY ASSOCIATED WITH MINT

(71) Applicant: InterDigital Patent Holdings, Inc., Wilmington, DE (US)

(72) Inventors: Taimoor Abbas, Sainte-Julie (CA); Behrouz Aghili, Commack, NY (US); Xiaoyan Shi, Lake Oswego, OR (US); Anuj Sethi, Ottawa (CA); Samir Ferdi, Kirkland (CA); Michelle Perras, Montreal (CA)

(73) Assignee: InterDigital Patent Holdings, Inc., Wilmington, DE (US)

(21) Appl. No.: 18/293,943

(22) PCT Filed: Jul. 29, 2022
(86) PCT No.: PCT/US2022/038846

§ 371 Date: Jan. 31, 2024

Related U.S. Application Data
(60) Provisional application No. 63/229,937, filed on Aug. 5, 2021.

(51) Int. Cl. H04W 40/24; H04W 8/00; H04W 40/22; H04W 76/14

(52) U.S. Cl. CPC H04W 40/246; H04W 40/22; H04W 76/14; H04W 8/005

(57) ABSTRACT

Systems, methods, and instrumentalities are described herein that are associated with providing access to a network (e.g., if access to a different network is lost, affected, etc.). A WTRU may act as a relay to another WTRU, For example, a first VVTRU may act as a relay WTRU (e.g., a VVTRU to network relay, such as a proximity services (ProSe) WTRU to network relay) towards a second WTRU (e.g., a remote WTRU). The first WTRU may provide discovery and/or connection establishment associated with the second WTRU accessing the network (e.g., if there is a service disruption to another network).

### CROSS-REFERENCE TO RELATED APPLICATIONS

The application claims the benefit of U.S. Provisional Application 63/229,937, filed Aug. 5, 2021, the contents of which are incorporated by reference in their entirety herein.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are described herein that are associated with providing access to a network (e.g., if access to a network is lost, affected, etc.). A wireless transmit receive unit (WTRU) may act as a relay to another WTRU that has lost network access, e.g. due to a disaster. For example, a first WTRU may act as a relay WTRU (e.g., a WTRU to network relay, such as a proximity services (ProSe) WTRU-to-network relay) towards a second WTRU (e.g., a remote WTRU). The first WTRU may provide discovery and/or connection establishment associated with the second WTRU accessing the network (e.g., if there is a service disruption to another network).

The first WTRU may receive (e.g., from a first network) a first message (e.g., via a system information block). The first message may indicate that a network condition exists associated with a second network (e.g., that there is a condition affecting the second network, a part of the second network, an area of the second network, etc.). The indicated network condition may be a disaster condition, such as an outage, associated with the second network, a part of the second network, an area of the second network, etc. The first message may be received from a network entity (e.g., from a network entity such as a base station or a network entity associated with a base station). The network condition may affect WTRUs associated with the second network, such as the second WTRU. For example, a WTRU that subscribes to a wireless provider associated with the second network may be affected.

The first WTRU may send a second message (e.g., in response to the indication in the first message). The second message may be a broadcast message. The second message may indicate the network condition (e.g., the disaster condition, a service disruption or outage associated with the second network, etc.), for example to a WTRU that receives the second message, such as the second WTRU. In examples, the first WTRU may send an indication of an available PLMN (e.g., where the indication of the available PLMN may be comprised in the second message and/or may comprise a PLMN ID). The first WTRU may receive a third message (e.g., in response to the second message). The third message may be received from the second WTRU. The third message may indicate a request for a service (e.g., associated with the network condition). The third message may indicate one or more of the following: a service code associated with the requested service, a PLMN ID (e.g., an ID of a PLMN the second WTRU is requesting to access), or an ID associated with the first WTRU. In examples, the PLMN associated with the PLMN ID may be associated with a different wireless provider than the wireless provider of the second network (e.g., the second WTRU may not subscribe to the wireless provider associated with the PLMN ID. In examples, the service is a minimization of service interruption service.

The first WTRU may (e.g., in response to the third message) determine that the second WTRU is allowed to access the PLMN associated with the PLMN ID and/or send a fourth message to the second WTRU. The fourth message may indicate that the second WTRU is authorized to use the service. The fourth message may indicate a code to be used by the second WTRU to access the service. The first WTRU may (e.g., before sending the fourth message) verify the network condition with the network. If the first WTRU is in an idle operational condition (e.g., CM-IDLE) when the first WTRU receives the third message, the first WTRU may trigger a service request to the first network and connect to the first network. The determination of whether the second WTRU is allowed to access the PLMN associated with the PLMN ID may comprise checking whether the PLMN allows access to roaming WTRUs (e.g.; inbound roamers, such as inbound roamers associated with a disaster condition). In examples, the first WTRU may determine that the second WTRU is allowed to access the PLMN if the first WTRU determines that a number of WTRUs accessing the first PLMN is under a threshold.

The first WTRU may register with the first network (e.g., before receiving the first message). The network may (e.g., as part of or after the registration) provision the first WTRU to act as a relay WTRU (e.g., a WTRU to network relay) and/or send indication(s) of the network condition (e.g., the disaster condition, a service disruption, etc.), such as the indication in the second message, based on receiving an indication that the network condition exists. For example, the first WTRU may be provisioned to act as described herein to broadcast to WTRUs (e.g., including the second WTRU) to enable such WTRUs to access a network.

The first WTRU may determine (e.g., receive an indication) that the network condition has been cleared (e.g., access to the second WTRU's subscribed network is available). The first WTRU may (e.g., in response to such determination) send a fifth message that indicates the service is no longer available. In examples, the first WTRU and the second WTRU may be end user devices.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of a proximity based service (ProSe) direct discovery (e.g., 5G ProSe direct discovery) with a model (e.g., model A).

FIG. 3 illustrates an example of ProSe direct discovery (e.g. 5G ProSe direct discover) with a model (e.g., model B).

FIG. 4 illustrates an example of an architecture model using a ProSe WTRU-to-network relay.

FIG. 5 illustrates an example of a ProSe WTRU-to-network relay.

FIG. 6 illustrates an example of providing information pertaining to a disaster condition of a public land mobile network (PLMN) to a WTRU via a network (e.g., a non-3GPP Interworking function (N3IWF)) and providing a connection via a relay WTRU.

FIG. 7 illustrates an example of providing information pertaining to a disaster condition of a PLMN to a WTRU via a relay WTRU and providing a connection via the relay WTRU.

FIG. 8 illustrates an example of providing information pertaining to a disaster condition of a PLMN to a WTRU via a relay WTRU and providing a connection via the relay WTRU.

FIG. 9 illustrates an example of inquiring whether a disaster occurred and establishing a connection via a relay WTRU.

### DETAILED DESCRIPTION

Systems, methods, and instrumentalities are described herein for a proximity based service (ProSe) wireless transmit receive unit (WTRU)-to-network relay for minimization of service interruption (MINT). A ProSe WTRU-to-network relay may support MINT. A network may indicate a WTRU relay. A WTRU may broadcast a disaster notification to facilitate inbound roamers, e.g., based on MINT in an SIB. A relay WTRU may trigger a service request, e.g., based on a remote WTRU request. The relay WTRU may ask a non-disaster network (e.g., PLMN-A) about allowing inbound roamers. A relay WTRU may receive a disaster indication about a network (e.g., PLMN-D), e.g., via SIB. The relay WTRU may broadcast a message (e.g., disaster indication with the network ID) to discover remote WTRUs seeking relayed network access. A (e.g., NAS) message may check for a disaster condition, e.g., for a remote WTRU not receiving SIB. A relay WTRU may indicate “relayed MINT” capabilities. A relay WTRU may receive MINT authorization information (e.g., PLMNs and/or TAs for MINT). A relay WTRU may broadcast a MINT indication, e.g., if applicable.

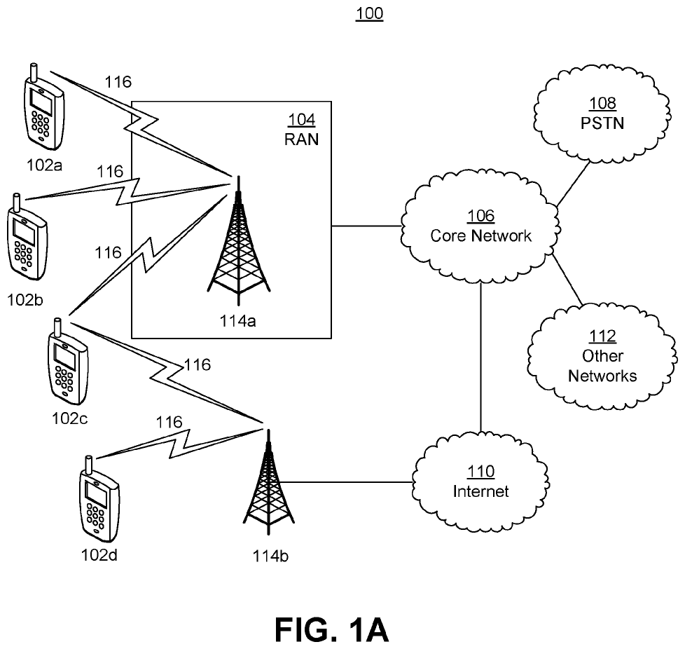

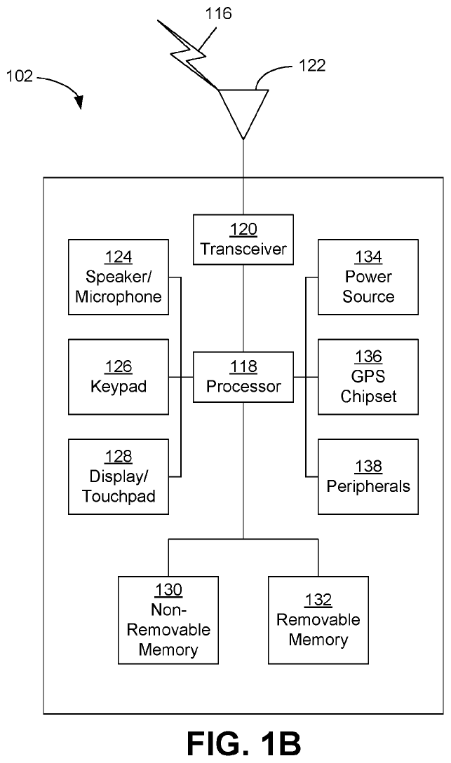

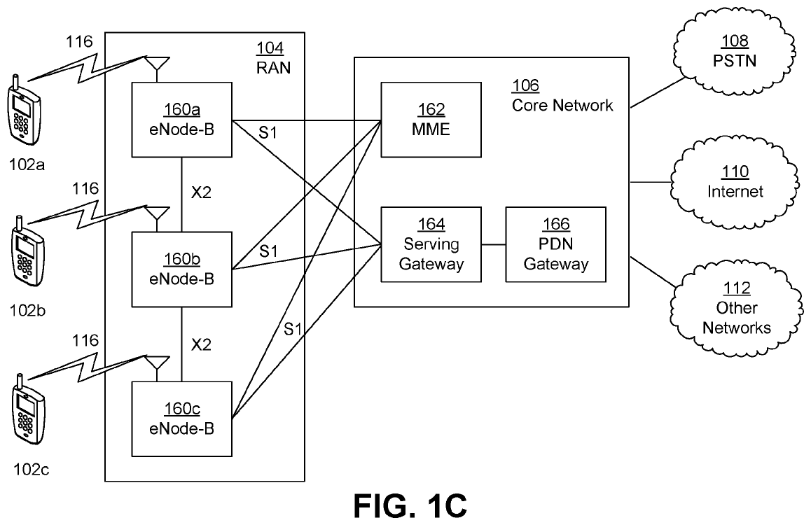

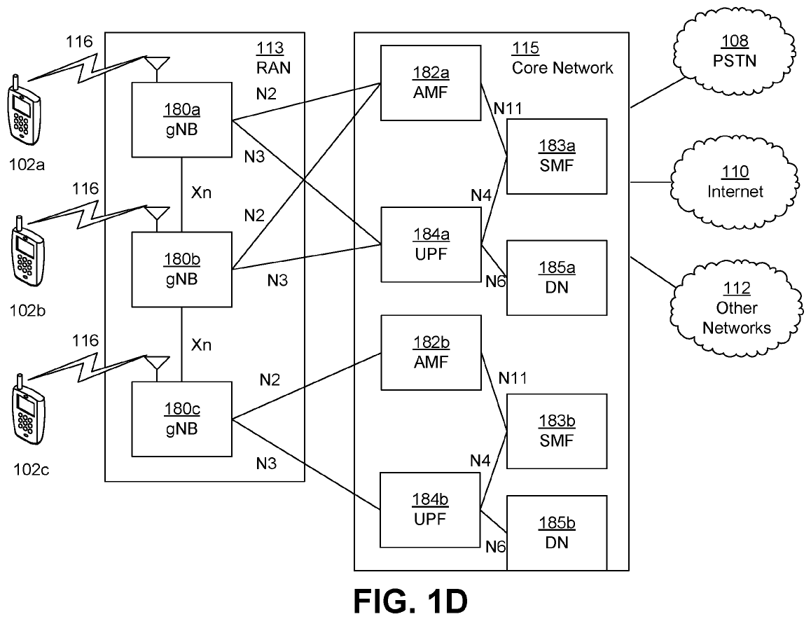

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SU-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like, Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband DMA (WCDMA). WCDMA may include communication protocols such as High-Speed Packet Access (HSPA) and/or Evolved HSPA (HSPA+), HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 18 as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (US8) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160a may be associated with a particular cell (not shown) and may be configured to handle radio resource management decisions, handover decisions, scheduling of users in the UL and/or DL, and the like. As shown in FIG. 10, the eNode-Bs 160a, 160b, 160c may communicate with one another over an X2 interface.

The CN 106 shown in FIG. 10 may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the ON operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz Wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b. 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like, A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-BS 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein that are associated with providing access to a network (e.g., if access to a different network is lost, affected, etc.). A WTRU may act as a relay to another WTRU. For example, a first WTRU may act as a relay WTRU (e.g., a WTRU to network relay, such as a proximity services (ProSe) WTRU-to-network relay) towards a second WTRU (e.g., a remote WTRU). The first WTRU may provide discovery and/or connection establishment associated with the second WTRU accessing the network (e.g., if there is a service disruption to another network).

The first WTRU may receive (e.g., from a first network) a first message (e.g., via a system information block). The first message may indicate that a network condition exists associated with a second network (e.g., that there is a condition affecting the second network, a part of the second network, an area of the second network, etc.). The indicated network condition may be a disaster condition, such as an outage, associated with the second network, a part of the second network, an area of the second network, etc. The first message may be received from a network entity (e.g. from a network entity such as a base station or a network entity associated with a base station). The network condition may affect WTRUs associated with the second network, such as the second WTRU. For example, a WTRU that subscribes to a wireless provider associated with the second network may be affected.

The first WTRU may send a second message (e.g., in response to the indication in the first message). The second message may be a broadcast message. The second message may indicate the network condition (e.g., the disaster condition, a service disruption or outage associated with the second network, etc.), for example to a WTRU that receives the second message, such as the second WTRU. In examples, the first WTRU may send an indication of an available PLMN (e.g., where the indication of the available PLMN may be comprised in the second message and/or may comprise a PLMN ID). The first WTRU may receive a third message (e.g. in response to the second message). The third message may be received from the second WTRU. The third message may indicate a request for a service (e.g., associated with the network condition). The third message may indicate one or more of the following: a service code associated with the requested service, a PLMN ID (e.g., an ID of a PLMN the second WTRU is requesting to access), or an ID associated with the first WTRU. In examples, the PLMN associated with the PLMN ID may be associated with a different wireless provider than the wireless provider of the second network (e.g., the second WTRU may not subscribe to the wireless provider associated with the PLMN ID. In examples, the service is a minimization of service interruption service.

The first WTRU may (e.g., in response to the third message) determine that the second WTRU is allowed to access the PLMN associated with the PLMN ID and/or send a fourth message to the second WTRU. The fourth message may indicate that the second WTRU is authorized to use the service. The fourth message may indicate a code to be used by the second WTRU to access the service. The first WTRU may (e.g., before sending the fourth message) verify the network condition with the network. If the first WTRU is in an idle operational condition (e.g., CM-IDLE) when the first WTRU receives the third message, the first WTRU may trigger a service request to the first network and connect to the first network. The determination of whether the second WTRU is allowed to access the PLMN associated with the PLMN ID may comprise checking whether the PLMN allows access to roaming WTRUs (e.g., inbound roamers, such as inbound roamers associated with a disaster condition). In examples, the first WTRU may determine that the second WTRU is allowed to access the PLMN if the first WTRU determines that a number of WTRUs accessing the first PLMN is under a threshold.

The first WTRU may register with the first network (e.g., before receiving the first message). The network may (e.g., as part of or after the registration) provision the first WTRU to act as a relay WTRU (e.g., a WTRU to network relay) and/or send indication(s) of the network condition (e.g., the disaster condition, a service disruption, etc.), such as the indication in the second message, based on receiving an indication that the network condition exists. For example, the first WTRU may be provisioned to act as described herein to broadcast to WTRUs (e.g., including the second WTRU) to enable such WTRUs to access a network.

The first WTRU may determine (e.g., receive an indication) that the network condition has been cleared (e.g., access to the second WTRU's subscribed network is available). The first WTRU may (e.g., in response to such determination) send a fifth message that indicates the service is no longer available. In examples, the first WTRU and the second WTRU may be end user devices.

Systems, methods, and instrumentalities are described herein that may be associated with a wireless transmit receive unit (WTRU)-to-network relay that provided service interruption services (e.g., minimization of service interruption (MINT) services), where a proximity services (ProSe) WTRU/ProSe WTRU relay may be used as examples herein.

For example, a network may indicate or inform a WTRU (e.g., in an initial registration) that the WTRU may act as a ProSe relay (e.g., ProSe user equipment (UE) (e.g., WTRU) to network (U2N) relay). The WTRU may broadcast a notification (e.g., disaster notification) to facilitate inbound roamers, for example, based on the WTRU determining that there is a service interruption indication (e.g., where a MINT indication may be used as an example herein), for example in a system information block (SIB).

The relay WTRU (e.g., a relay WTRU in a connection management (CM) idle (CM-IDLE) state) may trigger a service request, for example, based on (e.g., on a condition of receiving) a request from a remote WTRU. The relay WTRU (e.g., via the service request) may (e.g., include a check to) ask a network (e.g., a non-disaster network, such as a public land mobile network (PLMN) type A (PLMN-A)), whether the network (e.g., PLMN-A) allows inbound roamers.

The relay WTRU may receive a disaster indication about a network (e.g., a PLMN with a disaster condition (PLMN-D)), for example, via an SIB/SIBx. The relay WTRU may determine whether to broadcast the disaster indication (e.g., an indication of the disaster indication). The relay WTRU may (e.g., on a condition of having determined to broadcast an indication of the disaster indication) broadcast a disaster indication with the network identifier (ID) (e.g., PLMN-D ID). The relay WTRU may (e.g., also) broadcast a discovery announcement message, for example, to discover remote WTRUs that may seek or need network access (e.g., 3GPP) access via a relay (e.g., U2N relay).

A message (e.g., non-access stratum (NAS) message) may be sent by the relay WTRU to request confirmation of a disaster condition on behalf of a remote WTRU, for example, if/when a relay WTRU is in CM-connected operation (e.g., a CM-connected state or mode) and/or not receiving SIB/SIBx.

The relay WTRU may register with a network to provide service interruption services (e.g., a relayed minimization of service interruption capability (e.g., relayed MINT) capabilities). The relay WTRU may receive (e.g., from the network) MINT authorization information (e.g., PLMNs and/or tracking areas (TA) where MINT may apply). The relay WTRU may broadcast (e.g., start broadcasting) a MINT indication (e.g., over PC5), for example, if/when the relay WTRU detects that MINT applies for a PLMN and/or that a TA matches the MINT authorization information.

Service interruption services (e.g., where minimization of service interruption (MINT) may be used as an example herein) may be supported/provided by a WTRU (e.g., a relay WTRU, such as a ProSe WTRU-to-Network relay). In an example scenario, there may be a service interruption (e.g., where a disastrous event may be used as an example herein) somewhere in a network. An example of a disaster event may be a fire in a building where one or more network nodes and/or components reside. Additional examples (e.g., use cases) are described herein, but the examples are non-exclusive.

Proximity Services (ProSe) may be provided (e.g., by a 3GPP system), for example, based on WTRUs being in proximity to each other. WTRUs may perform a ProSe discovery procedure to discover other WTRUs in proximity, for example, to determine whether to provide proximity services.

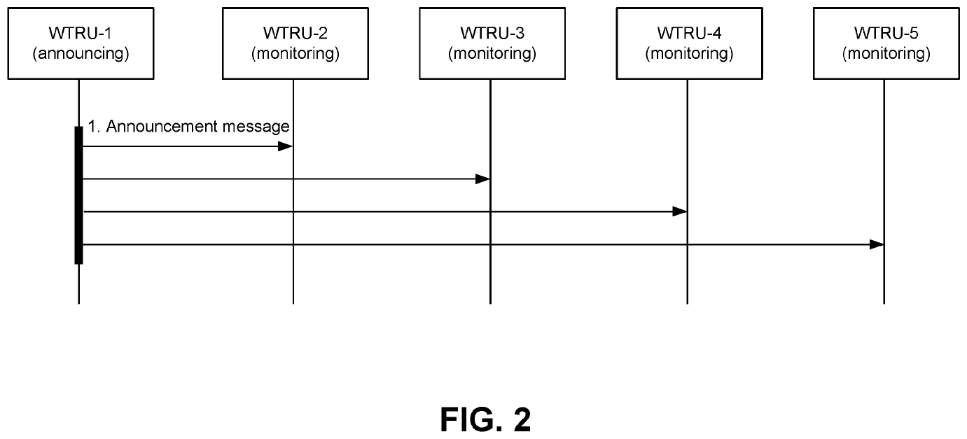

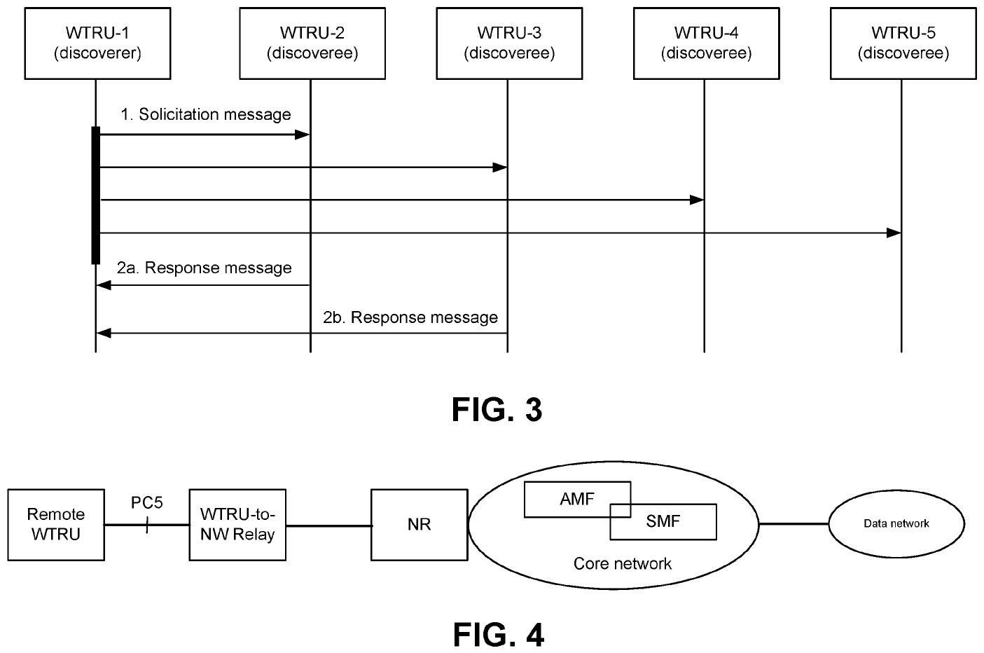

There may be multiple (e.g., two) ProSe discovery modes (e.g., model A and model B). FIGS. 2 and 3 show examples of ProSe discovery.

FIG. 2 illustrates an example of a proximity based service (ProSe) direct discovery (e.g., 5G ProSe direct discovery) with a model (e.g., model A).

In some examples (e.g., of model A), a WTRU (e.g., an announcing WTRU) may broadcast an announcement message, e.g., that may include a ProSe code. A ProSe code may be associated with an announcing WTRU's ID and/or a service provided by the announcing WTRU. A WTRU (e.g., a monitoring WTRU) that receives the announcement message may be (e.g., become) aware that the announcing WTRU is in proximity.

FIG. 3 illustrates an example of ProSe direct discovery (e.g., 5G ProSe direct discovery) with a model (e.g., model B). In some examples (e.g., of model B), a WTRU (e.g., a discoverer WTRU) may broadcast a solicitation request message with a ProSe query code, A ProSe query code may be associated with a WTRU's ID to be discovered and/or a ProSe service to be discovered. A WTRU (e.g., a discoveree WTRU) that receives a solicitation request message may respond to the request, e.g., with a ProSe response code. A ProSe response code may be associated with a discoveree WTRU's ID and/or a ProSe service provided by the discoveree WTRU. The discoverer WTRU may be (e.g., become) aware that the discoveree WTRU is in proximity (e.g., based on reception of the ProSe response code).

One or more (e.g., both) discovery modes may be used to perform group discovery, for example, to discover WTRUs that may belong to a specific group. One or more (e.g., both) discovery modes may be used to perform WTRU-to-Network relay discovery, for example, to discover a WTRU-to-Network relay that may provide connection with a (e.g., 5G) network.

A discovery message (e.g., an announcement and/or a solicitation request/response), for example, for group discovery, may include a group ID. A discovery message (e.g., an announcement and/or a solicitation request/response), for example, for WTRU-to-network relay discovery, may use a relay service code (e.g., instead of a ProSe code), for example, to indicate WTRU-to-network relay service.

A ProSe WTRU-to-network relay entity may provide functionality to support connectivity to the network for remote WTRUs (e g, as shown by example in FIG. 4).

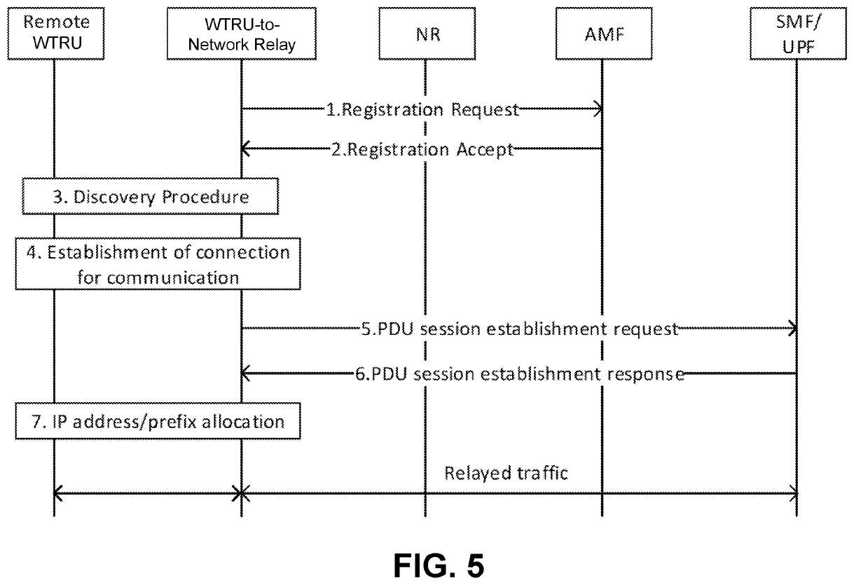

FIG. 4 illustrates an example of an architecture model using a ProSe WTRU-to-network relay. FIG. 5 illustrates an example of a ProSe WTRU-to-network relay. A remote WTRU may discover and select a WTRU-to-network relay, for example, if the remote WTRU is out of network coverage (e.g., new radio (NR) network coverage), cannot communicate (e.g., directly) with the core network, and/or is in (e.g., NR) network coverage and is configured to or prefers to use PC5 for communication. The remote WTRU may establish a PC5 session with (e.g., a discovered and/or selected) WTRU-to-network relay. The WTRU-to-network relay may establish a packet data unit (PDU) session (e.g., or a packet data network (PDN) connection in the evolved packet core (EPC)) for the remote WTRU. Traffic between the remote WTRU and the network may be relayed by the WTRU-to-network relay, for example, based on (e.g., after) IP address/prefix allocation (e.g., as shown by example in FIG. 5).

Notification of a disaster condition may be provided to a WTRU. Information pertaining to a disaster condition of a PLMN in an area may be delivered to a WTRU located in the area, for example, via a relay.

An indication of accessibility from one or more other PLMNs (e.g., without a disaster condition) may be provided to a WTRU. One or more PLMNs (e.g., other than the PLMN with the disaster condition) may indicate that they can accommodate disaster inbound roamers (e.g., WTRUs associated with the network with the disaster condition), for example, via a relay. Information may be provided to potential disaster inbound roamers.

Registration may be performed with a roaming PLMN (e.g., a PLMN without a disaster condition able to accommodate roaming WTRUs from the network with the disaster condition). A registration procedure (e.g., initiated by an inbound disaster roamer) may be performed, for example, via a relay. A disaster roaming PLMN may limit the area of service to inbound disaster roamers to a region (e.g., a region where the disaster condition applies and/or a region using different relays).

In some examples, notification (e.g., of a disaster condition) may be provided to a WTRU, for example, via a network node, such as a non-3GPP interworking function (N3IWF), which may be used as an example. A connection may be provided via a relay WTRU.

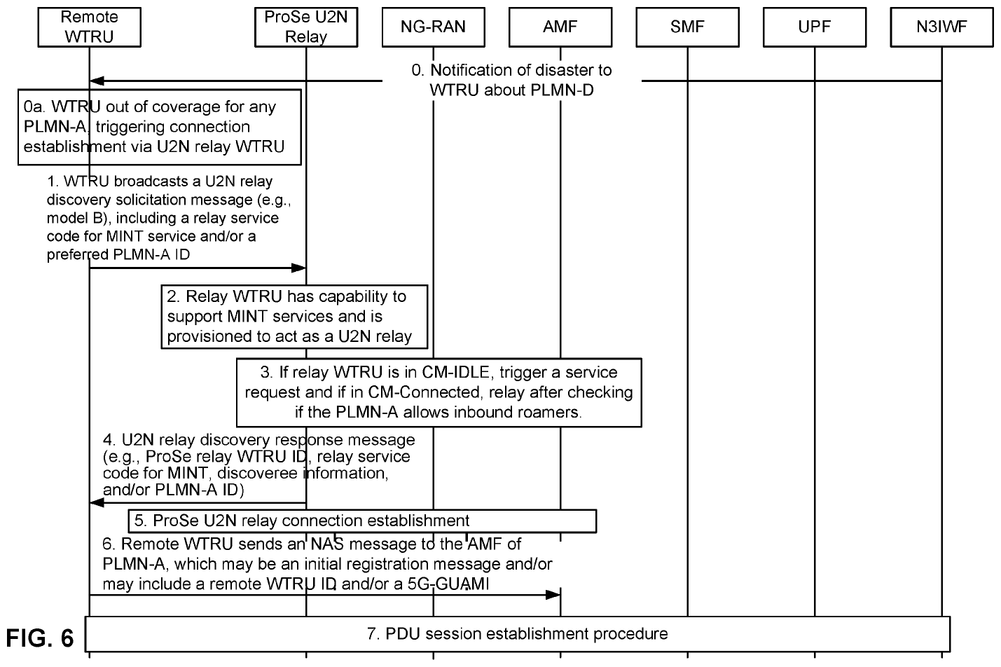

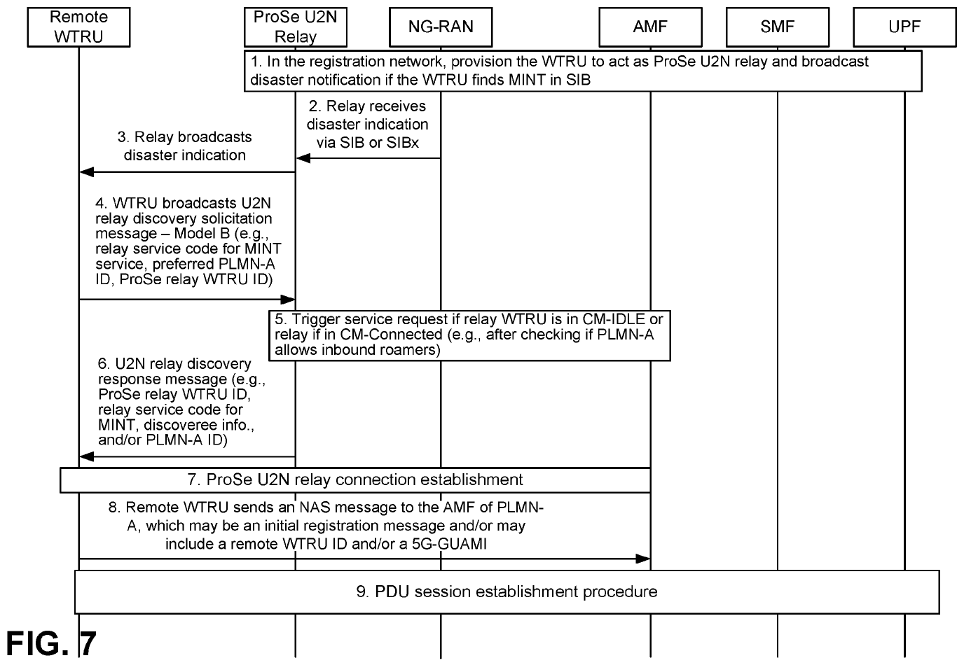

FIG. 6 illustrates an example of providing information pertaining to a disaster condition of a public land mobile network (PLMN) to a WTRU via a network node (e.g., a non-3GPP Interworking function (N3IWF, which is used as an example)). A connection may be provided via a relay WTRU.

As shown by example in FIG. 6, a remote WTRU may be registered. A session may be established in one or more PLMNs, for example, via 3GPP access and/or trusted/untrusted non-3GPP access. At 0, the remote WTRU may receive a disaster notification for PLMN-D (e.g., via non-3GPP access), for example, if the PLMN providing 3GPP access to the remote WTRU goes into a disaster condition and the remote WTRU remains connected via non-3GPP access. The remote WTRU may receive a list of PLMNs that are offering inbound roaming (e.g., access) to disaster WTRUs.

At 0a, the remote WTRU may be out of coverage for available PLMNs (PLMN-As), for example, a PLMN offering inbound roaming services for a WTRU belonging to a PLMN that has a disaster condition (PLMN-D). The remote WTRU may (e.g., based on the remote WTRU being out of coverage) trigger connection establishment. The connection establishment may be triggered, for example, via a relay WTRU (e.g., U2N relay WTRU used as an example).

At 1, a remote WTRU may broadcast a discovery solicitation message (e.g., a U2N relay discovery solicitation message used as an example), which may be associated with Model-B. A solicitation message may include, for example, a relay service code for a service (e.g., MINT service used as an example) and/or a list of PLMN IDs (e.g., preferred PLMN IDs), where for example the list may include one or more PLMN-A IDs.

At 2, a relay WTRU (e.g., with a capability to support a MINT service(s)) may be provisioned to act as a U2N relay. The relay WTRU may be provisioned with service specific parameters (e.g., MINT-specific parameters may be used as an example), which may include, for example, one or more of the following: a maximum number of WTRUs that may be served for MINT; a maximum bandwidth allocated per remote WTRU, per slice, per relay service code, or per PDU session; a maximum throughput per remote WTRU, per slice, per relay service code, or per PDU session; and the like. One or more actions described in the figures, such as FIG. 6, may not be performed or may be performed in a different order than shown in the example figure.

Multiple relay service codes for MINT may be provisioned on the relay WTRU. Relay service codes may have different priorities. Different priorities may allow, for example, higher priority remote WTRUs to (e.g., always) be served (e.g., without condition(s)) and/or lower priority remote WTRUs to be served conditionally (e.g., if limits allow service).

At 3, the relay WTRU (e.g., in an idle operating condition, for example CM-IDLE) may trigger a service request. The relay WTRU (e.g. in a connected condition, for example CM-connected) may perform a relay function, for example, after checking whether the PLMN-A allows inbound roamers, e.g., by sending a request to the network (e.g., an access and mobility management function (AMF)). A rejection may occur (e.g., at 4), for example, if the PLMN of relay WTRU does not allow more inbound roamers. A rejection may include a reject cause (e.g., PLMN-A congested and/or other reason(s)). The relay WTRU (e.g., if more roamers for PLMN-A are rejected) may (e.g., until more roamers are allowed), for example, stop advertising support for MINT in PLMN-A in discovery messages and/or stop sending responses to discovery solicitation requests.

At 4, a response message (e.g., a U2N relay discovery response message) may be sent from the relay WTRU to the remote WTRU, for example, if the relay has matched the relay service code and/or the PLMN-A ID to which the relay is connected to. A response message may indicate acceptance or rejection.

At 5, the remote WTRU may establish a connection (e.g., a PC5 connection) with the relay WTRU (e.g. if the discovery response indicates acceptance). The relay WTRU may establish (e.g., or may have already established) an RRC connection with the NG-RAN. A NAS connection may be set up.

At 6, the remote WTRU may send a NAS message to PLMN-A (e.g., the AMF of PLMN-A.) The NAS message may be an initial registration message, for example, with one or more parameters, e.g., for MINT service. The parameters (e.g., for MINT service) may include, for example, a mobile identity (e.g., a 5G system (5GS) mobile identity). A mobile identity may be provided, for example, in the form of subscription concealed identifier (SUCI) or subscription permanent identifier (SUPI), (e.g., not a globally unique temporary identifier (GUTI)). The AMF of PLMN-A may send (e.g., directly send) the remote WTRU information for authorization, e.g., to a unified data management (UDM) function for authorization. The parameters (e.g., for MINT service) and/or the remote WTRU information may include, for example, an ID such as a (e.g., 5G) globally unique AMF ID (GUAMI), which may indicate the last status of the remote WTRU.

At 7, the Remote WTRU may trigger a PDU session establishment procedure.

In some examples, a notification (e.g., of a disaster condition) may be provided to a remote WTRU, for example, via a relay WTRU. A connection may be provided to the remote WTRU, for example, via the relay WTRU (e.g., model B).

FIG. 7 illustrates an example of providing information pertaining to a disaster condition of a PLMN to a remote WTRU via a relay WTRU and providing a connection via the relay WTRU.

As shown by example in FIG. 7, at 1, a relay WTRU may be provisioned/configured with U2N relay capabilities and/or with a service enabled (e.g., MINT support enabled used as an example). For example, the relay WTRU may receive an indication from the network to act as relay (e.g., ProSe U2N relay) and/or broadcast a network condition indication (e.g., disaster indication) if the relay WTRU detects a network indication (e.g., receives/detects a network condition indication from the network (e.g., a MINT indication), which may be in a received message such as a SIB).

At 2, the relay WTRU may receive an indication that a network condition exists (e.g., a disaster indication), e.g., where the network condition indication is an indication (e.g., disaster indication) about PLMN-D. The disaster indication may be received, for example, via a PLMN-A (e.g. a message from PLMN-A, such as a SIB/SIBx).

At 3, the relay WTRU may broadcast an indication of the network condition (e.g., disaster indication). The disaster indication may indicate the PLMN-D ID associated with the disaster indication (e.g., the ID associated with the network experiencing the network condition).

At 4, the remote WTRU may broadcast a request message, for example a U2N relay discovery solicitation message (e.g., Model-B). The message may include, for example, one or more of the following: a code associated with a requested service (e.g., relay service code for MINT service), a relay WTRU ID (e.g., ProSe relay WTRU ID), or a preferred PLMN-A ID. The remote WTRU may receive a disaster indication from one or more than one relay WTRU.

At 5, the relay WTRU (e.g., is in a connected mode, for example CM-connected) may relay the request to the network, for example, after checking whether the PLMN-A allows inbound roamers (e.g., by sending a request to AMF). The relay WTRU (e.g., if in an idle operational condition, for example CM-IDLE) may trigger a service request (e.g., before checking and/or relaying). A rejection may occur (e.g., at 4), for example, if the PLMN-A of the relay WTRU does not allow more inbound roamers. A rejection may include a reject cause (e.g., PLMN-A congested and/or other reason(s)). The relay WTRU (e.g., if more roamers for PLMN-A are rejected) may (e.g., until more roamers are allowed) stop advertising support for service(s) (e.g., MINT service(s)) in PLMN-A in discovery messages and/or stop sending responses to discovery solicitation requests.

At 6, a response message (e.g., a U2N relay discovery response message) may be sent from the relay WTRU that matched the relay service code and PLMN-A ID to the remote WTRU. For example, the response message may indicate that the remote WTRU may connect with the PLMN-A via relay WTRU.

The response message may include one or more of the following: an ID associated with the relay WTRU (e.g., a ProSe relay WTRU ID); a service code (e.g., the code associated with the requested service, for example MINT service(s)); discoveree information (e.g., an ID associated with the relay WTRU, a service code (e.g., the code associated with the requested service), etc.); or, a PLMN-A ID.

At 7, the remote WTRU may establish a connection (e.g., PC5 connection) with the relay WTRU. The relay WTRU may establish or may have already established a connection with the network (e.g., an RRC connection with the NG-RAN). The NAS connection may be set up.

At 8, the remote WTRU may send (e.g., via the relay WTRU) a NAS message to the network (e.g., to the AMF of PLMN-A). The NAS message may be an initial registration message with one or more parameters for a service, such as a MINT service (e.g., as indicated herein). The remote WTRU (e.g., if an L3 relay is assumed) may (e.g., alternatively) establish a connection with the network (NW) via a non-3GPP access (e.g., via an N3IWF interface).

At 9, the remote WTRU may trigger a PDU session establishment procedure.

In some examples, notification (e.g., of a disaster condition) may be provided to a WTRU, for example, via a relay WTRU. A connection may be provided via the relay WTRU (e.g., model A).

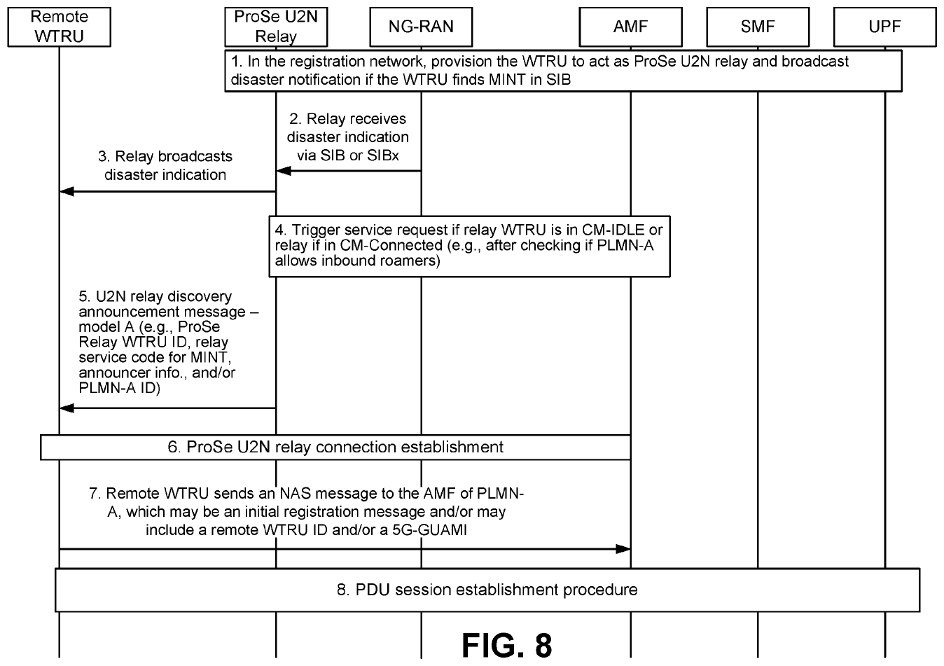

FIG. 8 illustrates an example of providing information pertaining to a network condition (e.g., disaster condition) of a PLMN to a remote WTRU via a relay WTRU and providing a connection via the relay WTRU.

As shown by example in FIG. 8, at 1, the network can indicate to a WTRU (e.g., in an initial registration) that the WTRU can act as a relay WTRU (e.g., ProSe U2N relay), for example, if the network determines that the WTRU supports PC5 for ProSe. The relay WTRU may broadcast a notification to facilitate inbound roamers (e.g., remote WTRU(s) associated with a network that is experiencing a network condition, such as a disaster condition), for example, if the relay WTRU detects a network indication (e.g., receives/detects a network condition indication from the network (e.g., a MINT indication), which may be in a received message such as a SIB).

At 2, the relay may receive an indication that a network condition exists (e.g., a disaster indication), e.g., where the network condition indication is an indication (e.g., disaster indication) about PLMN-D. The disaster indication may be received, for example, via a PLMN-A (e.g., a message from PLMN-A, such as a SIB/SIBx).

At 3, the relay WTRU may broadcast an indication of the network condition (e.g., a disaster indication). The disaster indication may indicate the PLMN-D ID associated with the disaster indication (e.g. the ID associated with the network experiencing the network condition).

At 4, the relay WTRU (e.g., if in an idle operational condition, for example CM-IDLE) may trigger a service request. The relay WTRU (e.g., if in a connected operational condition, for example CM-connected) may initiate discovery or relay, for example, after checking whether the PLMN-A allows inbound roamers (e.g., as described herein).

At 5, a the relay WTRU may send a message (e.g., a U2N relay discovery announcement message) that indicates availability of the relay WTRU to serve as a relay for access to an available network, for example PLMN-A as described herein. The discovery announcement message may include one or more of the following: an ID associated with the relay WTRU (e.g., a ProSe relay WTRU ID); a relay service code for a service (e.g., a service code for MINT); announcer information; or a PLMN-A ID.

At 6, a remote WTRU may establish a connection (e.g., a PC5 connection) With the relay WTRU (e.g., ProSe U2N relay WTRU). The relay WTRU (e.g., ProSe WTRU to NW relay) may establish or may have already established a connection with the network (e.g., an RRC connection with the NG-RAN). A NAS connection may be set up.

At 7, the remote WTRU may send (e.g., via the relay WTRU) a NAS message to the network (e.g., AMF of PLMN-A). The NAS message may be an initial registration message with one or more parameters for the service (e.g., MINT service). The remote WTRU (e.g., if an L3 relay is assumed) may (e.g., alternatively) establish a connection with the network via non-3GPP access (e.g., via an N3IWF interface).

At 8, the remote WTRU may trigger a PDU session establishment procedure.

In some examples, a remote WTRU may inquire whether a disaster has occurred. The remote WTRU may establish a connection via a relay WTRU.

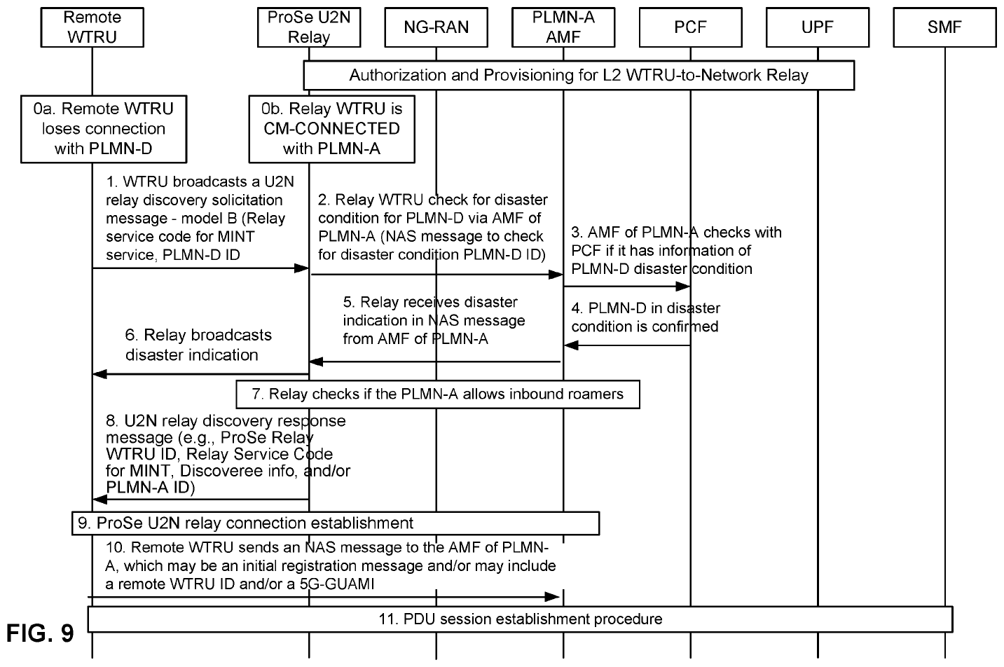

FIG. 9 illustrates an example of a remote WTRU inquiring whether a network condition exists (e.g., whether a disaster occurred) and establishing a connection to an available network via a relay WTRU.

As shown by example in FIG. 9, at 0, a relay WTRU (e.g., ProSe WTRU-to-network relay) may be authorized and provisioned by the network (e.g., to act as a relay), for example as described herein.

At 0a, the remote WTRU may lose a connection with PLMN-D (e.g., the last registered PLMN).

At 0b, the relay WTRU may be connected (e.g., CM-CONNECTED) with PLMN-A (e.g., a different PLMN than the PLMN to which the remote WTRU belongs).

At 1, the remote WTRU may broadcast a request message (e.g., a U2N relay discovery solicitation message) to determine whether a disaster happened to PLMN-D.

At 2, the relay WTRU may send a message to check with the available network (e.g., PLMN-A) for a disaster condition for PLMN-D, for example, the relay WTRU may send a message via an AMF of PLMN-A (e.g., an NAS message, an information element (IE) in an NAS message, etc).

At 3, the available network may check whether PLMN-D has a disaster condition (e.g., an AMF of PLMN-A may check with PCF whether PLMN-D has a disaster condition (e.g., request disaster confirmation).

At 4, a policy control function (PCF) of PLMN-A may indicate (e.g., confirm by an indication) that PLMN-D has a disaster.

At 5, the relay WTRU may receive an indication (e.g., confirmation) of a disaster for PLMN-D, for example, in an NAS message from the network (e.g., AMF of PLMN-A).

At 6, the relay WTRU may broadcast an indication of the network condition (e.g., a disaster indication). The disaster indication may indicate the PLMN-D ID associated with the disaster indication (e.g., the ID associated with the network experiencing the network condition, PLMN-D). The relay WTRU may (e.g., as part of the indication) send a list of available PLMN(s) (e.g., which may include associated PLMN-A ID(s)) that are available, e.g., available in the disaster area. The relay WTRU may (e.g., before broadcasting the disaster indication) verify whether the PLMNs are available to offer a service, for example MINT service(s) used as an example. An example verification may be to check whether the maximum number of remote WTRUs for MINT has been reached. The broadcast message may include (e.g., only include) an indication of the PLMNs allowing remote WTRUs, e.g., for MINT. The relay WTRU may (e.g., autonomously, additionally, and/or alternatively) initiate a PDU session establishment (e.g., establish a PDU session) that may be used for remote WTRUs that were served by PLMN-D and are allowed to use PLMN-A because of a disaster. The relay WTRU may send a message/notification to remote WTRUs associated with and/or using the established MINT PDU session indicating that, if the disaster condition is cleared, the disaster condition is cleared (e.g., this may be a direct notification instead of broadcasting notification). The relay may indicate, e.g., in the notification, a cause code, which for example may be a part of a link release request, e.g., if/when the MINT service is no longer applicable.

At 7, the relay WTRU may check with the network whether the PLMN-A allows inbound roamers (e.g., via the AMF).

At 8, a response message (e.g., a U2N relay discovery response message) may be sent from the relay WTRU that matched relay service code and PLMN-A ID to the remote WTRU. For example, the response message may indicate that the remote WTRU may connect with the PLMN-A via relay WTRU.

The response message may include one or more of the following: an ID associated with the relay WTRU (e.g., a ProSe relay WTRU ID); a service code (e.g., the code associated with the requested service, for example MINT service(s)): discoveree information: or, a PLMN-A ID.

At 9, the remote WTRU may establish a connection (e.g., a PC5 connection) with the relay WTRU (e.g., ProSe U2N relay WTRU). The relay WTRU (e.g., ProSe WTRU to NW relay) may establish or may have already established a connection with the network (e.g., an RRC connection with the NG-RAN). The NAS connection may be set up.

At 10, the remote WTRU may send (e.g., via the relay WTRU) a NAS message to the network (e.g., to the AMF of PLMN-A). The NAS message may be an initial registration message with one or more parameters for a service, such as a MINT service. The remote WTRU (e.g., if an L3 relay is assumed) may (e.g., alternatively) establish a connection with the NW via non-3GPP access (e.g., via an N3IWF interface).

At 11 the remote WTRU may trigger a PDU session establishment procedure.

In some examples, a relay WTRU may be authorized to provide a service (e.g., MINT service). A relay WTRU may be authorized by a first network to provide a “relayed MINT” service for a second network. The relay may provide a “relayed MINT” capability during registration.

The relay WTRU may receive relayed MINT authorization information, for example, in a registration accept and/or a WTRU configuration update (UCU). MINT authorization information may include, for example, a list of authorized PLMNs for which MINT may be provided, a list of tracking areas (TAs) where MINT can be provided, etc. Authorization for the relay to provide MINT service may be granted or revoked, for example, at any time (e.g. using a UCU). For example, authorization may be granted or revoked, respectively, if/when entering or leaving a TA where disaster roaming is available.

The relay WTRU may broadcast (e.g., start broadcasting) a MINT indication (e.g., over P5), for example, if/when the relay detects a matching authorized PLMN with MINT information in the SIB and/or if/when the relay enters an authorized TA where MINT applies.

The relay may stop broadcasting a MINT indication (e.g., over PC5), for example, if/when a matching authorized PLMN is not found with MINT information in the SIB, if/when the relay leaves an authorized TA where MINT applies, and/or if/when authorization is revoked by the network (e.g., UCU).

The relay WTRU may send one or more solicitation responses for MINT (e.g., over PC5), for example, if/when the relay receives one or more solicitation requests, if/when the relay detects a matching authorized PLMN with MINT information in the SIB, and/or if/when the relay WTRU enters an authorized TA where MINT applies.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor.

Examples of computer-readable media include, but are not limited to, electronic signals (transmitted over wired and/or wireless connections) and/or computer-readable storage media. Examples of computer-readable storage media include, but are not limited to a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-15. (canceled)

16. A first wireless transmit/receive unit (WTRU) comprising:
a processor configured to:
receive, from a network node, a first message that indicates a network condition;
send a second message to a second WTRU, wherein the second message indicates the network condition, and wherein the second message is a broadcast message;
receive a third message from the second WTRU, wherein the third message indicates a request for a service associated with the network condition, a public land mobile network (PLMN) identifier (ID), and an ID associated with the first WTRU;
determine, based on the network condition, that the second WTRU is allowed to access a PLMN associated with the PLMN ID; and
send a fourth message to the second WTRU when it is determined that the second WTRU is allowed to access the PLMN, wherein the fourth message indicates that the second WTRU is authorized to use the service, and wherein the fourth message indicates a code to be used by the second WTRU to access the service.

17. The first WTRU of claim 16, wherein the processor is further configured to:
send a service request message to the network node, wherein the service request message requests an indication as to whether the network node allows an inbound roaming WTRU;
receive a service response message from the network node, wherein the service response message indicates that the network node allows the inbound roaming WTRU; and
send a connection request message to the network node if the PLMN allows the inbounding roaming WTRU.

18. The first WTRU of claim 16, wherein the processor is further configured to receive an authorization message from the network node, wherein the authorization message indicates that the first WTRU is to act as a relay for the service associated with the network condition.

19. The first WTRU of claim 16, wherein the processor is further configured to send a discovery response message to the second WTRU, wherein the discovery response message indicates an available PLMN, and wherein the available PLMN is the PLMN.

20. The first WTRU of claim 16, wherein the second message further indicates that the PLMN is an available PLMN and indicates the PLMN ID.

21. The first WTRU of claim 16, wherein the processor being configured to determine that the second WTRU is allowed to access the PLMN comprises the processor being configured to determine that a number of WTRUs accessing the PLMN is under a threshold.

22. The first WTRU of claim 16, wherein the processor is further configured to:
determine that the network condition has been cleared; and
send a fifth message to the second WTRU that indicates the service is no longer available.

23. The first WTRU of claim 16, wherein the PLMN is a first PLMN, wherein the network condition is a condition where access to a second PLMN is unavailable for at least an area, wherein the service is a minimization of service interruption service, wherein the first PLMN is associated with a first provider, and wherein the second PLMN is associated with a second provider.

24. The first WTRU of claim 16, wherein the first WTRU is a relay WTRU, wherein the second WTRU is a remote WTRU, wherein the first WTRU is associated with a first user, and wherein the second WTRU is associated with a second user.

25. The first WTRU of claim 16, wherein the processor is further configured to verify the network condition by determining if the PLMN or the network node permits access to an inbound roaming device associated with a disaster condition.

26. A method performed by a first wireless transmit/receive unit (WTRU), the method comprising:
receiving, from a network node, a first message that indicates a network condition;
sending a second message to a second WTRU, wherein the second message indicates the network condition, and wherein the second message is a broadcast message;
receiving a third message from the second WTRU, wherein the third message indicates a request for a service associated with the network condition, a public land mobile network (PLMN) identifier (ID), and an ID associated with the first WTRU;
determining, based on the network condition, that the second WTRU is allowed to access a PLMN associated with the PLMN ID; and
sending a fourth message to the second WTRU when it is determined that the second WTRU is allowed to access the PLMN, wherein the fourth message indicates that the second WTRU is authorized to use the service, and wherein the fourth message indicates a code to be used by the second WTRU to access the service.

27. The method of claim 26, further comprising:
sending a service request message to the network node, wherein the service request message requests an indication as to whether the PLMN allows an inbound roaming WTRU;
receive a service response message from the network node, wherein the service response message indicates that the PLMN allows the inbound roaming WTRU; and
send a connection request message to the network node if the PLMN allows the inbounding roaming WTRU.

28. The method of claim 26, further comprising receiving an authorization message from the network node, wherein the authorization message indicates that the first WTRU is to act as a relay for the service associated with the network condition.

29. The method of claim 26, further comprising sending a discovery response message to the second WTRU, wherein the discovery response message indicates an available PLMN, and wherein the available PLMN is the PLMN.

30. The method of claim 26, wherein the second message further indicate that the PLMN is an available PLMN and indicates the PLMN ID.

31. The method of claim 26, wherein determining that the second WTRU is allowed to access the PLMN comprises determining that a number of WTRUs accessing the PLMN is under a threshold.

32. The method of claim 26, wherein the first WTRU is a relay WTRU, wherein the second WTRU is a remote WTRU, wherein the first WTRU is associated with a first user, and wherein the second WTRU is associated with a second user.

33. The method of claim 26, wherein the method further comprises verifying the network condition by determining if the PLMN permits access to an inbound roaming device associated with a disaster condition.

34. The method of claim 26, wherein the method further comprises:
determining that the network condition has been cleared; and
sending a fifth message to the second WTRU that indicates the service is no longer available.

35. The method of claim 26, wherein the PLMN is a first PLMN, wherein the network condition is a condition where access to a second PLMN is unavailable for at least an area, wherein the service is a minimization of service interruption service, wherein the first PLMN is associated with a first provider, and wherein the second PLMN is associated with a second provider.
